(19) United States
(12) Patent Application Publication
(10) Pub. No.: US 2007/0146483 A1
(43) Pub. Date: Jun. 28, 2007

(54) Injection apparatus and injection method

(76) Inventors: Moritoshi Ando, Kawasaki (JP); Sachihiro Youoku, Kawasaki (JP); Akio Ito, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/402,821

(22) Filed: Apr. 13, 2006

(30) Foreign Application Priority Data
Dec. 28, 2005 (JP) 2005-380039

(51) Int. Cl. H04N 7/18

(52) U.S. Cl. 348/159

(57) ABSTRACT

A capturing unit captures an image of a designated position in a culture medium. A first creating unit creates a wide-field image by synthesizing a plurality of images of the designated position and a periphery of the designated position captured by the capturing unit. A second creating unit creates a narrow-field image using the image of the designated position. A displaying unit arranges and displays the wide-field image and the narrow-field image.

### BACKGROUND OF THE INVENTION

1. Field of the Invention

The present invention relates to a technology for improving an efficiency of injecting a substance into a cell in a culture medium using a micro capillary and simplifying a configuration of an injection apparatus.

2. Description of the Related Art

Recently, a study for altering genetic information in a cell is frequently performed by directly injecting a gene into a cell. With a further advance of the study, it is expected that the role of the gene will be clarified, and for example, a tailor-made medication of performing a gene therapy suitable for individual genetic characteristics will be possible. As a method of injecting a gene into a cell includes an electrical method (electroporation), a chemical method (lipofection), a biological method (vector method), a mechanical method (microinjection), and an optical method (optoporation) have been proposed. However, the electrical method largely damages the cell because a cell membrane is broken by letting heavy-current flow in the cell; the chemical method is less efficient because genes to which the method may be introduced are limited; and the biological method cannot confirm safety because all materials cannot be introduced. On the contrary, the mechanical method is highly noted as the safest and most efficient method.

In the mechanical method, as disclosed in, for example, Japanese Patent No. 2553150, an image of a cell magnified by a microscope is capture by a camera, an operator decides a position of a needle called a capillary while confirming the captured image displayed on a monitor, and injects the gene by letting the capillary puncture the cell.

FIG. 24 is a schematic of a conventional microinjection apparatus. In the microinjection apparatus, a dish 1, in which a culture solution with attachment cells is filled, is loaded on a movable stage 2 that is movable in a horizontal direction. The attachment cells in the dish 1 to which light from a light source 3 is radiated is magnified by an objective lens 4a or an objective lens 4b mounted on a revolver 4c of an objective lens unit 4 (the objective lens 4b in the example shown in FIG. 24). The image magnified by the objective lens 4a or the objective lens 4b is reflected in a direction to a camera 8 by a reflector 6, and imaging is made at a position of a lens of the camera 8 by an imaging lens 7.

The magnified image of the cell is captured by the camera 8 and is displayed on a monitor (not shown). The operator moves the movable stage 2 to adjust the position of the dish 1 to confirm the magnified image of the cell displayed on the monitor, and after determining the position, operates the capillary 5 to inject a chemical such as a gene into the cell.

In such a microinjection apparatus, it is necessary to classify and inject a cell nucleus or a cytoplasm in the cell in response to a purpose of the injection. Therefore, in a cell of size of about several micrometers, because a position of each cell organelle must be accurately confirmed to control the capillary 5, an objective lens of high magnification must be inevitably used. With this reason, in the microinjection apparatus, a plurality of objective lenses 4a, 4b of different magnifications are generally mounted on the revolver 4c, and the cell is designed to be magnified by an objective lens of desired magnification by turning the revolver 4c in a direction of the arrow shown in FIG. 24.

In general, because a dish is much bigger than a cell, when injection is performed, an observation area in which the cell of interest is present must be properly determined from the inside of the dish. In this case, in the observation area, it is necessary that a cell density be an appropriate extent such that each cell can be classified and observed. Namely, it is necessary to search an area of proper cell density, as in a frame 12 shown in FIG. 25B, not an area that cells are densely populated and each cell is overlapped, as shown in FIG. 25A, or an area that cells are not present, as in a frame 11 shown in FIG. 25B. To search the area of proper cell density, because an objective lens of high magnification has a narrow field and its efficiency is poor, it is designed to turn the revolver to change the lens to an objective lens of low magnification and wide field.

However, if injection is performed on a plurality of cells by alternately repeating the search of an appropriate observation area and injection, it is laborious because an objective lens of high magnification and an objective lens of low magnification must be changed each time. As a result, the efficiency of the injection becomes down, resulting in a time-consuming process. In addition, because a plurality of objective lenses of different magnifications is required, a revolver on which the lenses are mounted is also required, leading to a complicated configuration of the unit.

### SUMMARY OF THE INVENTION

It is an object of the present invention to at least solve the problems in the conventional technology.

An injection apparatus according to one aspect of the present invention includes a capturing unit that captures an image of a designated position in a culture medium; a first creating unit that creates a wide-field image by synthesizing a plurality of images of the designated position and a periphery of the designated position captured by the capturing unit; a second creating unit that creates a narrow-field image using the image of the designated position captured by the capturing unit; and a displaying unit that arranges and displays the wide-field image and the narrow-field image.

A method of displaying an image including a cell when injecting a substance into the cell in a culture medium using a micro capillary, according to another aspect of the-present invention, includes first capturing including capturing images of a designated position in the culture medium and a periphery of the designated position; first creating including creating a wide-field image by synthesizing the images of the designated position and the periphery of the designated position captured at the, first capturing; second capturing including capturing an image of the designated position in the culture medium; second creating including creating a narrow-field image using the image of the designated position captured at the second capturing; and arranging and displaying the wide-field image and the narrow-field image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an injection apparatus according to a first embodiment of the present invention;

FIG. 2A is a schematic of a movable stage periphery according to the first embodiment;

FIG. 2B is a schematic of a dish holder according to the first embodiment;

FIG. 2C is a schematic for illustrating a positioning of a dish according to the first embodiment;

FIG. 2D is a schematic of another configuration of the dish holder according to the first embodiment;

FIG. 3 is a schematic for illustrating a condition of a cell in the dish;

FIG. 4 is a schematic for illustrating a concept of an injection;

FIGS. 5A and 5B are schematics for illustrating a basic operation of the injection;

FIG. 6 is a block diagram of an image processing unit according to the first embodiment;

FIG. 7 is a flowchart of a processing procedure for an operation of the image processing unit according to the first embodiment;

FIG. 8 is a flowchart of a processing procedure for a synthesized-image creation processing according to the first embodiment;

FIG. 9 is a schematic for illustrating a process of creating a synthesized image according to the first embodiment;

FIG. 10 is a schematic for illustrating a change of range of the synthesized image according to the first embodiment;

FIG. 11 is a schematic for illustrating an example of a peripheral edge highlighting in the synthesized image according to the first embodiment;

FIG. 12A is a schematic for illustrating an example of a cell present on a border of an image according to the first embodiment;

FIG. 12B is a schematic for illustrating a processing of the cell present on the border of the image according to the first embodiment;

FIG. 13 is a flowchart of a processing procedure for a center-image creation process according to the first embodiment;

FIG. 14A is a schematic for illustrating a creating operating of a center image according to the first embodiment;

FIG. 14B is a schematic for illustrating a process of creating the center image according to the first embodiment;

FIG. 15 is a schematic for illustrating an example of a display on a monitor according to the first embodiment;

FIG. 16 is a schematic for illustrating an example of a method of designating an injection position according to the first embodiment;

FIG. 17 is a schematic for illustrating an example of marking according to the first embodiment;

FIG. 18 is a schematic for illustrating a process of creating a differential image according to the first embodiment;

FIG. 19 is a block diagram of an image processing unit according to a second embodiment of the present invention;

FIG. 20A is a schematic for illustrating an example of a process of creating a map according to the second embodiment;

FIG. 20B is a schematic for illustrating an example of the map according to the second embodiment;

FIG. 21 is a schematic for illustrating another example of the map according to the second embodiment;

FIG. 22 is a schematic for illustrating still another example of the map according to the second embodiment;

FIG. 23A is a schematic for illustrating a movable range of a cell;

FIG. 23B is a schematic for illustrating still another example of the map according to the second embodiment;

FIG. 24 is a schematic for illustrating of an example of a conventional microinjection apparatus;

FIG. 25A is a schematic for illustrating an example of a condition of high cell density; and

FIG. 25B is a schematic for illustrating a cell density suitable for an injection.

### DETAILED DESCRIPTION OF THE PREFERRED EMBODIMENTS

Exemplary embodiments of the present invention will be explained in detail below with reference to the accompanying drawings.

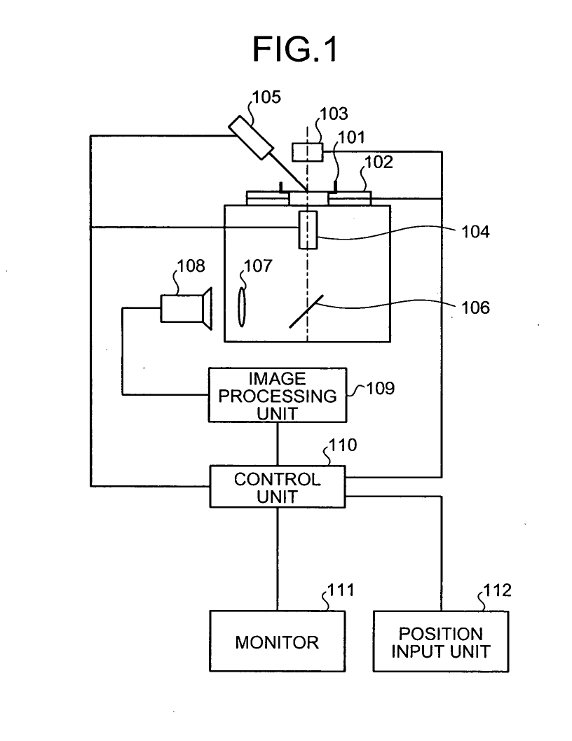

FIG. 1 is a schematic of an injection apparatus according to a first embodiment of the present invention. The injection apparatus includes a movable stage 102 on which a dish 101 is loaded, a light source 103, an objective lens 104, a capillary 105, a reflector 106, an imaging lens 107, a charge-coupled device (CCD) camera 108, an image processing unit 109, a control unit 110, a monitor 111, and a position input unit 112.

The movable stage 102 is movably provided in a horizontal direction and adjusts the position of the dish 101 loaded on the upper surface thereof in accordance with the control of the control unit 110. The light source 103 radiates light to the dish 101 in accordance with the control of the control unit 110 to give luminous energy required to observe cells in the dish 101.

The objective lens 104 is a lens of high magnification and narrow-field that magnifies the cells in the dish 101. The magnification of the objective lens 104 is, for example, an extent such that cells of four to five are included in the field and is an extent such that each cell or cell organelle may be clearly observed. In addition, the objective-lens 104 controls its focus in magnifying the cells in the dish 101 in accordance with the control of the control unit 110.

The capillary 105 that is of a needle at the top of the side on the dish 101 and injects a substance such as a gene into the cell present at the position input in the position input unit 112 in the dish 101 in accordance with the control of the control unit 110. The reflector 106 reflects the magnified image obtained by magnifying an object by the objective lens 104 in a direction to the CCD camera 108. The imaging lens 107 images the magnified image obtained by magnifying the object by the objective lens 104 at the position of the lens of the camera 8. The camera 8 captures the magnified image formed by the imaging lens 107 and outputs the captured image to the image processing unit 109.

The image processing unit 109 performs an image processing on the image captured by the CCD camera 108, and outputs the obtained image to the control unit 110. Concretely, the image processing unit 109 outputs a synthesized image obtained by connecting a plurality of images and a center image in the synthesized image, creates an image highlighting an edge periphery detected in the cell in the image, and syntheses a plurality of images of different focuses. A further concrete image processing by the image processing unit 109 will be described in detail later.

The control unit 110 displays the image output from the image processing unit 109 in the monitor 111. In addition, the control unit 110 moves the movable stage 102 in accordance with an instruction from the image processing unit 109, instructs the capillary 105 to perform injection, adjust the focus of the objective lens 104 and controls the on-off state of the light by the light source 103.

The monitor 111 displays the image output from the image processing unit 109 to the control unit 110. In this case, the monitor 111 arranges and displays the synthesized image where a plurality of images is connected and the center image located at the center of the synthesized image. The position input unit 112 instructs the control unit 110 to execute the control so as to allow the capturing of the position and the injection to be performed by the designation of the operator upon receipt of the operation of the operator visually observing the monitor 111.

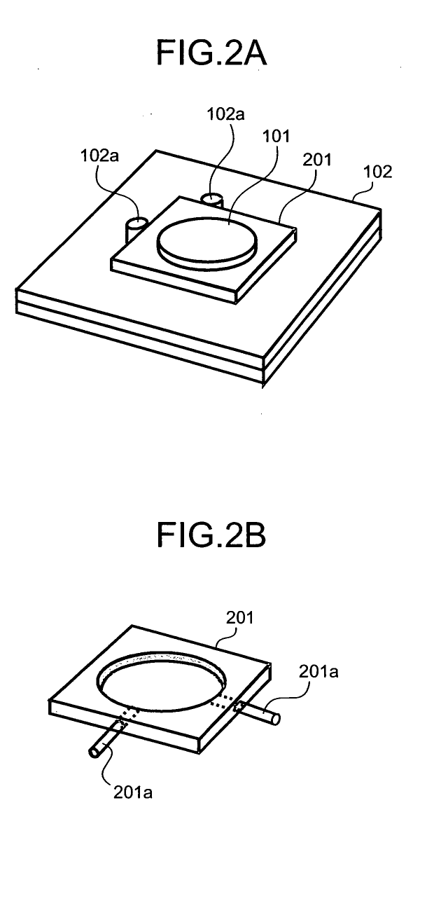

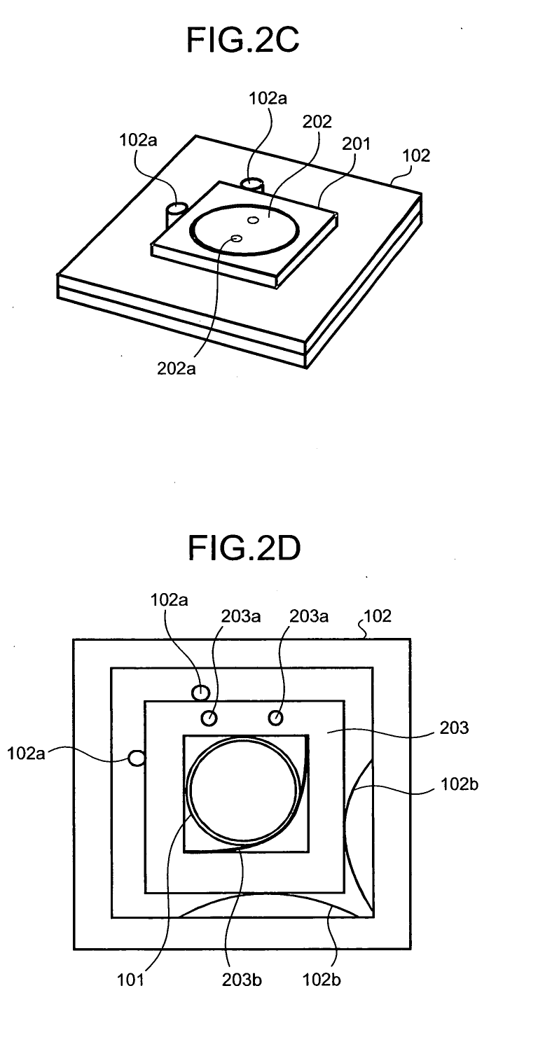

FIG. 2A is a schematic of the dish 101 and the movable stage 102. The dish 101 is fitted into a hole provided at the center of a dish holder 201 and is loaded on the upper surface of the movable stage 102. In this case, by allowing the dish holder 201 to contact with a positioning pin 102a protrusively provided on the upper surface of the movable stage 102 and to be loaded, the position of the dish 101 can be always fixed. Further, a dish presser 201a pressurized in the central direction of the hole at the center by the spring which is not illustrated is formed in the dish holder 201, and the position of the dish 101 fitted into the hole can be further securely fixed, as shown in FIG. 2B.

In addition, if the dish 101 is loaded on the movable stage 102 of a different unit, the position of the dish 101 can be always fixed, for example, by disposing a positioning member 202 shown in FIG. 2C at the central hole of the dish holder 201 and adjusting the coordinates of an opening hole 202a protrusively provided at the positioning member 202 so as to allow the coordinates thereof between different units to be reproduced. In addition, by using a dish holder 203 shown in FIG. 2D in place of the dish holder 201, the coordinates of an opening hole 203a provided at the dish holder 203 may be adjusted, thereby dispensing with the positing member. Further, by providing a pressing spring 102b at the movable stage 102, the dish holder 203 is securely contacted with the positioning pin 102a. In addition, by providing a pressing spring 203b at the dish holder 203 also, the position of the dish 101 in the dish holder 203 is also fixed. For example, a predetermined mark such as a cross mark may be used in place of the opening hole 202a of the positioning member 202 and the opening hole 203a of the dish holder 203.

Thus, because the dish 101 can be always fixed at the same position, even if the dish 101 is moved once to another place after injecting the cell, the position on the movable stage 102 can be easily reproduced to accurately observe the effect.

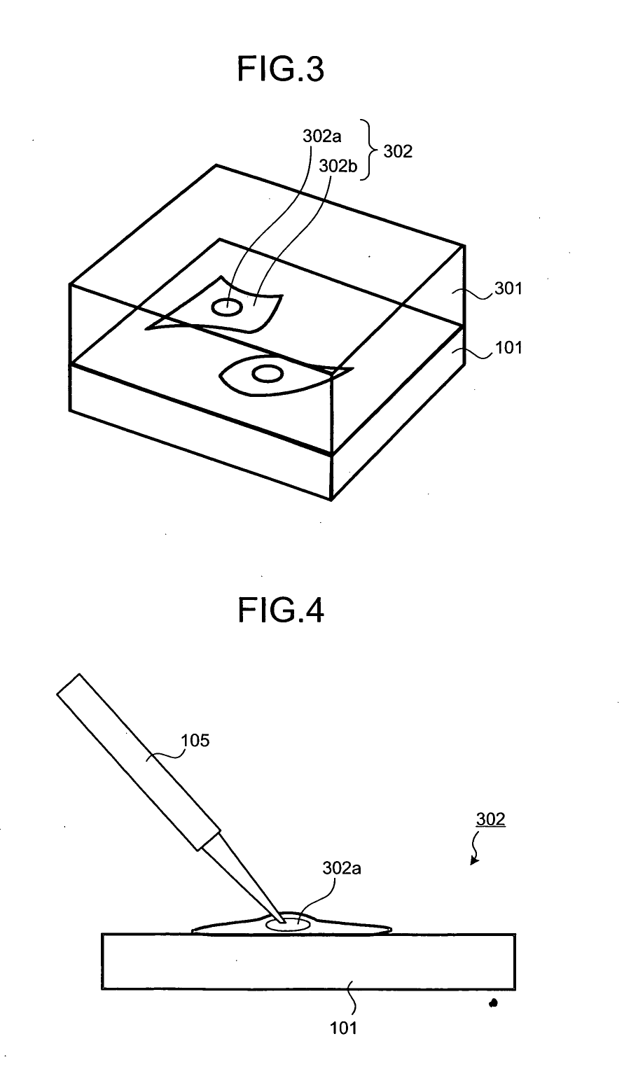

FIG. 3 is a schematic for illustrating a condition of a cell in the dish 101. A culture solution 301 is filled in the dish 101, if an adherent cell is placed into the culture solution 301, a cell 302 adheres to the upper surface of the dish 101 as a certain time elapses. The cell 302 comprises a cell nucleus 302a and a cytoplasm 302b containing various kinds of cell organelles. For example, when substances such as genes are injected into the cell nucleus 302a of the cell 302, as shown FIG. 4, the top of the capillary 5 is punctured into the cell nucleus 302a, and the substance is injected into the cell nucleus 302a. In addition, in FIG. 4, the illustration of the culture solution 301 is omitted.

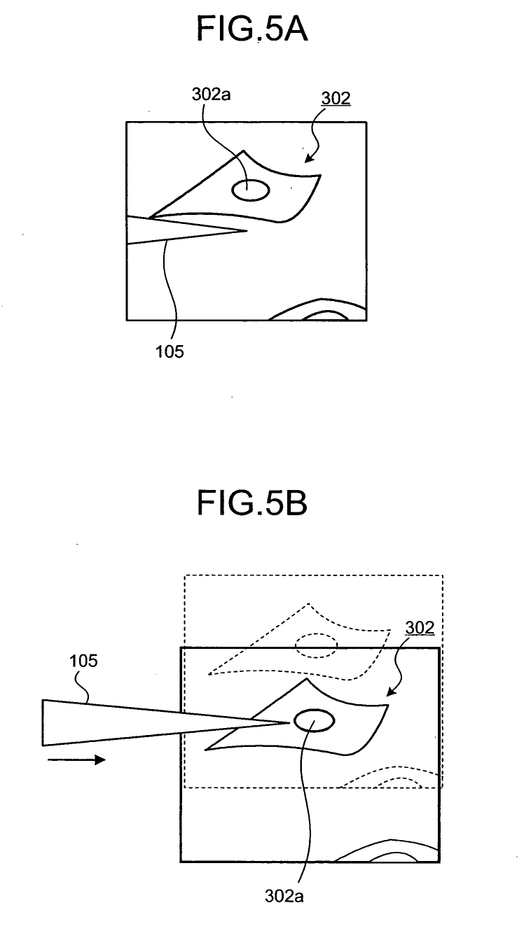

In this case, the magnified image magnified by the objective lens 104 is as shown in, for example, FIG. 5A. Namely, the position of the top of the capillary 5 and that of the cell nucleus 302a of the cell 302 are not aligned. Then, by the operator operating the position input unit 112 to designate the position of the cell nucleus 302a as an injection position, the movable stage 102 is moved by the control of the control unit 110, as shown in FIG. 5B, the position of the top of the capillary 5 and that of the cell nucleus 302a are aligned on the same line. Afterwards, the capillary 5 is moved in a direction of the arrow in FIG. 5B to allow the top of the capillary 5 to puncture the cell nucleus 302a. In addition, here, by moving the movable stage 102, the position of the top of the capillary 5 and that of the cell nucleus 302a are designed to be aligned on the same line, however, the capillary 5 may be moved. Thus, in the embodiment, because the injection is performed immediately after the position of the injection is designated, it is unnecessary to store the coordinates of the designated injection position.

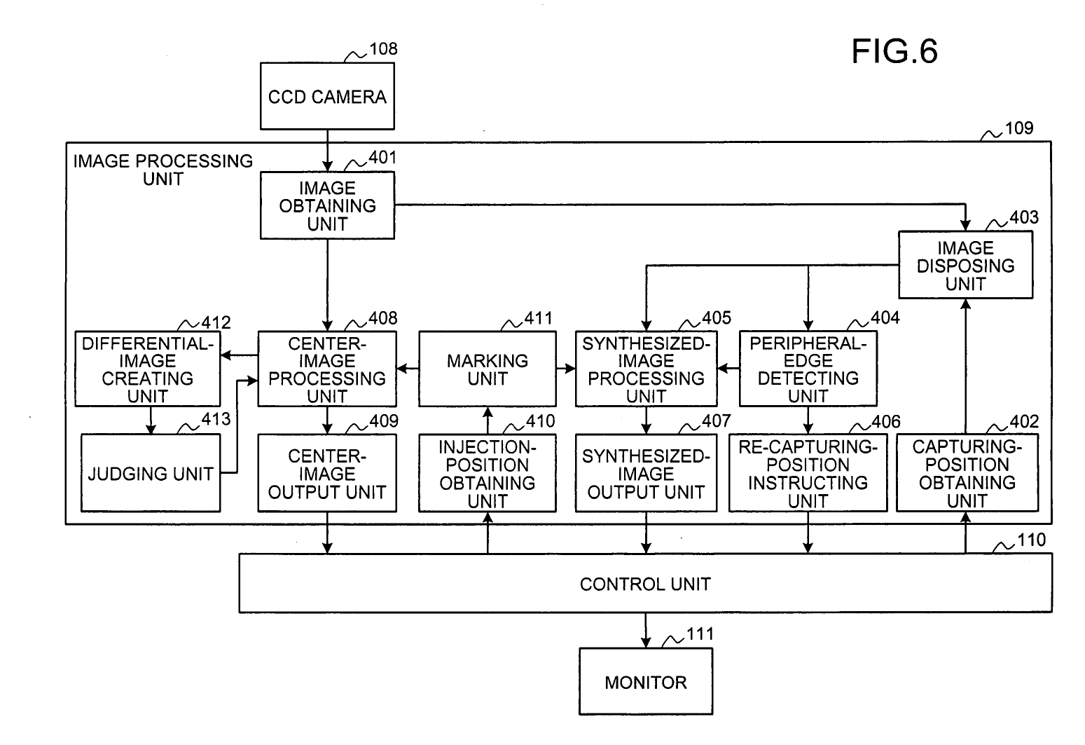

FIG. 6 is a block diagram of the image processing unit 109 according to the first embodiment. The image processing unit 109 includes an image obtaining unit 401, a capturing-position obtaining unit 402, an image disposing unit 403, a peripheral-edge detecting unit 404, a synthesized-image processing unit 405, a re-capturing-position instructing unit 406, a synthesized-image output unit 407, a center-image processing unit 408, a center-image output unit 409, an injection-position obtaining unit 410, a marking unit 411, a differential-image creating unit 412, and a judging unit 413.

The image obtaining unit 401 obtains an image captured by the CCD camera 108, and outputs the same to the image disposing unit 403 or the center-image processing unit 408. Concretely, the image obtaining unit 401 outputs an observation area search image captured by the CCD camera 108 while the movable stage 102 is being moved within a certain time, and outputs observation images captured by the CCD camera 108 when the movable stage 102 is stopped for a certain time or more to the center-image processing unit 408.

The capturing-position obtaining unit 402 obtains information on the capturing position of the image captured by the CCD camera 108 from the control unit 110. The image disposing unit 403 disposes a plurality of images output from the image obtaining unit 401 in accordance with the capturing position obtained by the capturing-position obtaining unit 402, and creates a synthesized image for observation area search. In the embodiment, the image disposing unit 403 creates the synthesized image by disposing the total nine images where 3 images are arranged vertically and horizontally. However, the number of images disposed by the image disposing unit 403 is, for example, 25 images where 5 images are arranged vertically and horizontally may be allowed, or the numbers of vertical and horizontal images may not be the same. Thus, by arranging and disposing a plurality of images, the conditions such as a peripheral cell density may be grasped.

The peripheral-edge detecting unit 404 performs edge detecting including a differential processing in the synthesized image obtained in the image disposing unit 403 to sense the edge periphery of the cell in the synthesized image. The synthesized-image processing unit 405 performs various processes in displaying the synthesized image obtained in the image disposing unit 403 in the monitor 111. Concretely, the synthesized-image processing unit 405 highlights the peripheral edges of the cells detected by the peripheral-edge detecting unit 404, for example, by tracing the same in thick line, or the like in the synthesized image. In addition, the synthesized-image processing unit 405 overrides and synthesizes the images re-captured in cell unit with regard to cells located on the borders between each image in the synthesized image. Further, the synthesized-image processing unit 405 marks the cells after injected in the synthesized image in accordance with the direction of the marking unit 411 to distinguish the injected cells from the cells before the injection.

The re-capturing-position instructing unit 406 extracts cells of which-peripheral edges intersect with the borders between individual images in the synthesized image as a result of the peripheral-edge detecting by the peripheral-edge detecting unit 404, and instructs the control unit 110 to re-capture the extracted cells. Namely, the re-capturing-position instructing unit 406 extracts cells spanning a plurality of images in the synthesized image and instructs the re-capturing of the cell. The control unit 110 received this direction moves the movable state 102 and instructs the CCD camera 108 to capture the directed position. The synthesized-image output-unit 407 outputs the synthesized image after processed to the control unit 110 after the synthesized image is processed by the synthesized-image processing unit 405. The output synthesized image is displayed on the monitor 111 by the control of the control unit 110.

The center-image processing unit 408 performs various processes in displaying the observing image output from the image obtaining unit 401 in the monitor 111. In addition, because the observing image output from the image obtaining unit 401 is an image at a position corresponding to the center image in the synthesized image created by the image disposing unit 403, hereinafter, the observing image is called “the center image”. Concretely, the center-image processing unit 408 synthesizes two center images of different focuses, and processes the same so as to allow both the cell membrane and cell organelle of the cell to be clarified. In this case, the center-image processing unit 408 may perform edge detecting in the center image, or the like, and highlight the peripheral edges of the cell. In addition, the center-image processing unit 408 marks the cell after injected in the center image in accordance with the direction of the marking unit 411 to distinguish the cell after injected from the cell before injected. Further, the center-image processing unit 408 makes the cell where the effect of the injection appears distinguishable by changing the color of the cell, or the like in accordance with the direction from the judging unit 413.

The center-image output unit 409 outputs the center image after processing to the control unit 110 if the center image is processed by the center-image processing unit 408. The output center image is displayed together with the synthesized image in the monitor 111.

The injection-position obtaining unit 410 obtains the information on the injection designated position input in the position input unit 112, in other words, obtains the information on the position of the cell to which the capillary 105 is punctured to execute the injection by the control of the control unit 110 from the control unit 110. The marking unit 411 instructs the synthesized-image processing unit 405 and the center-image processing unit 408 to mark the cell where the injection is executed in the synthesized image and the center image, respectively. Concretely, the marking unit 411 colors the image frame containing the cell where the injection is executed in the synthesized image and colors the peripheral edge of the cell where the injection is executed in the center image or adds a predetermined mark to a specific position in the cell.

The differential-image creating unit 412 obtains the image of the cell in the center image before the injection, re-obtains the image of the cell at the same position if the center image at the same position is obtained after the injection, and creates the differential image of the images of the cell before and after the injection. Namely, the differential-image creating unit 412 creates the differential image showing a portion where a change is made before and after the injection in the cell. In this case, the differential-image creating unit 412 may find a differential portion between the concentrations of the cell before and after the injection to create the differential image, or may find a differential portion in-shape from a change in profile lines of the cell to create the differential image. The judging unit 413 compares the size of the differential image with a predetermined threshold, judges that the injection is properly executed if the size of the differential image is bigger than the predetermined threshold, and reversely judges that the injection is not properly executed if the size of the-differential image is less than the predetermined threshold. And, the judging unit 413 instructs the center-image processing unit 408 to distinguish the cell where the injection is properly executed and the effect of the injection appears from other cells.

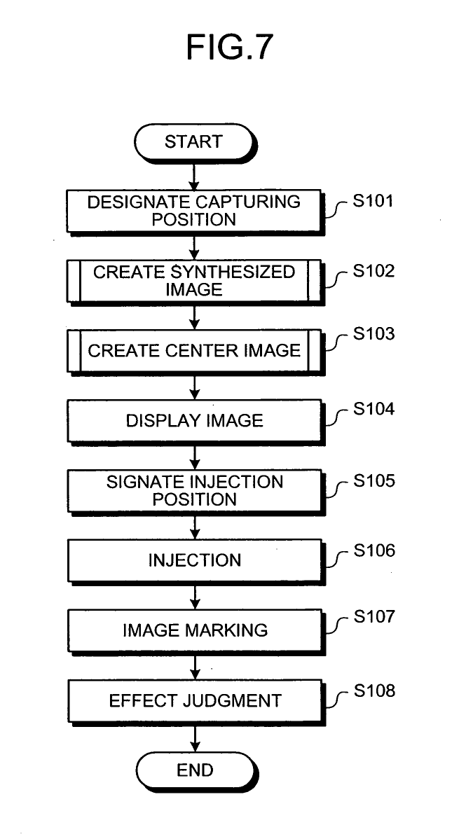

FIG. 7 is a flowchart of a processing procedure for an operation of the image processing unit 109 according to the first embodiment

The operator operates the position input unit 112 to move the movable stage 102 to a desired position and designates the position in the dish 101 that is captured by the CCD camera 108 (Step S101). When a capturing position is designated, the CCD camera 108 captures the magnified image of the dish 101, and synthesized image creating processing for observation area search is executed (Step S102).

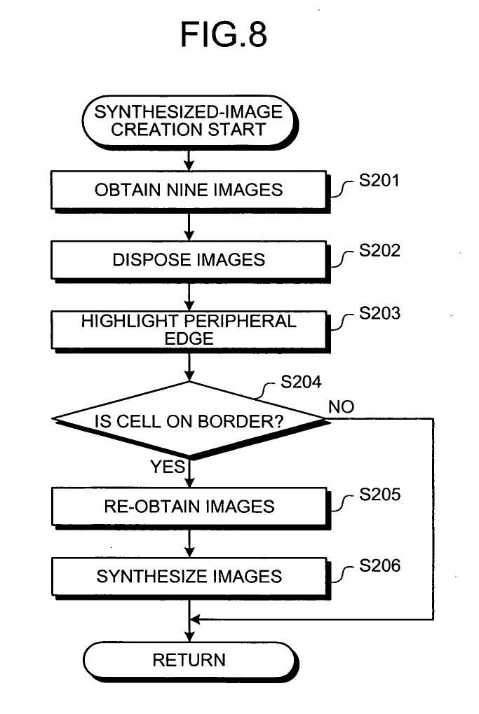

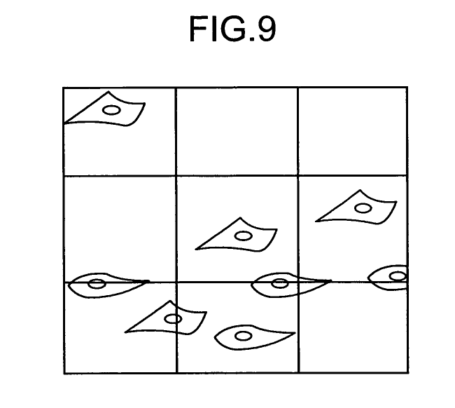

The synthesized image creating processing is executed in accordance with the procedure shown in FIG. 8. For example, as shown in FIG. 9, nine images in the periphery with the designated capturing position as the center are sequentially captured (Step S201). In this case, the movement of the movable stage 102 is controlled by the control unit 110, for example, the areas of the upper right image to that of the lower left image in FIG. 9 are sequentially captured images. In addition, the image obtaining unit 401 obtains the captured images and outputs the same to the image disposing unit 403. In addition, the capturing-position obtaining unit 402 obtains the capturing positions of each of nine images from the control unit 110 and outputs the same to the image disposing unit 403. In addition, what are captured here may not be inevitably nine images, as mentioned above.

The image disposing unit 403 disposes nine images in response to the capturing positions (Step S202). The obtained synthesized image is held in the synthesized-image processing unit 405, output from the synthesized-image output unit 407, and displayed on the monitor 111 through the control unit 110. In this case, the image size of the synthesized image is suitably contracted so as to be able to be displayed on the monitor 111. Therefore, even if the magnification of the objective lens 104 is high, the substantial magnification of the synthesized image is smaller than that of the objective lens 104.

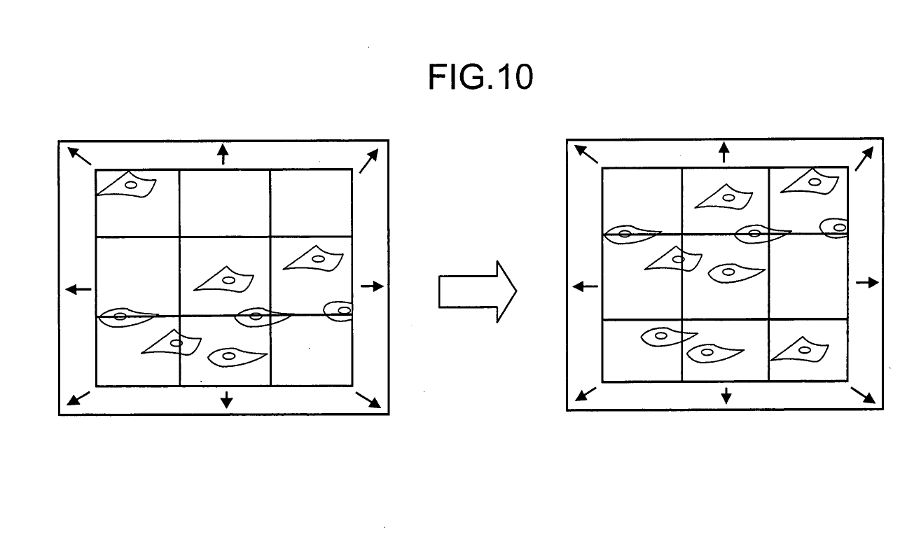

In this case, the arrows in the eight directions around the synthesized image are prepared to be displayed on the monitor 111, for example, as shown in FIG. 10, the operator may change the scope of the synthesized image while confirming the monitor 111. Namely, for example, in the left diagram in FIG. 10, if the operator operates the position input unit 112 to designate the lower arrow, the CCD camera 108 obtains the nine images again while the movable stage 102 is being moved again, as shown in FIG. 10, the scope of the synthesized image is changed in a lower direction by only one image portion.

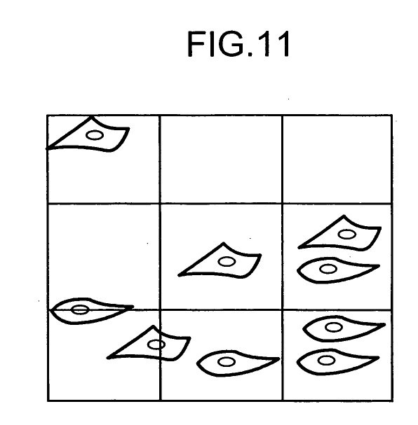

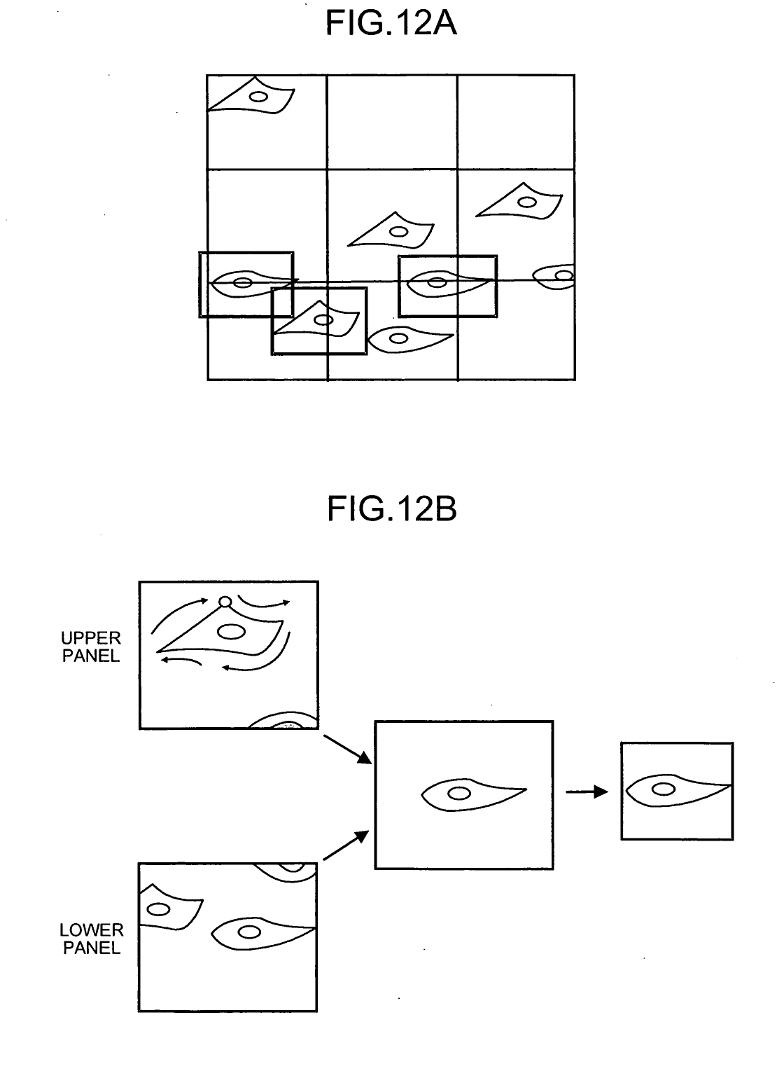

The peripheral-edge detecting unit 404 performs edge detecting from the synthesized image, and detects the profile line of the cell in the synthesized image. The detected profile line is highlighted such as shifted to thick line, or the like by the synthesized-image processing unit 405, for example, as shown in FIG. 11 (Step S203), and is displayed on the monitor 111 again. Further, if the peripheral-edge detecting unit 404 detects the profile line of the cell, the re-capturing-position instructing unit 406 judges whether a cell displayed crossing the borders of a plurality of the cells is present, for example, as in the cells enclosed by the black frames in FIG. 12A (Step S204). This judgment is conducted by judging that the cells are present on the borders of a plurality of images when the noted point of the white circle is moved along the profile line of the cell and the noted point intersects with the border of the cell, for example, as illustrated in the diagram in the upper panel of FIG. 12B. As a result, the re-capturing-position instructing unit 406 instructs the control unit 110 to re-capture the positions of the cells when the cells are present on the borders of a plurality of images. In addition, to judge whether the cells are present on the borders of the images, the operator may visually confirm the synthesized image displayed on the monitor 111 and input the positions of the cells present on the borders of the images in the position input unit 112, or the like.

If the control unit 110 receives a direction from the re-capturing-position instructing unit 406 to adjust the position of the movable stage 102, the CCD camera 108 re-captures the cells present on the borders of the images, and the image obtaining unit 401 obtains the obtained image again (Step S205). Namely, in FIG. 12B, the images of the cells present on the borders between the upper panel and the lower panel are obtained again (Refer to the diagram in FIG. 12B), and the image disposing unit 403 disposes the re-obtained images at the capturing positions. Further, after the synthesized-image processing unit 405 cuts off the re-obtained image in the minimum size containing the cell (refer to the right diagram in FIG. 12B), the image is overwritten on the synthesized image retained in the synthesized-image processing unit 405 and is synthesized (Step S206). The synthesized image thus obtained is again displayed on the monitor 111. This allows the cell off-displayed on the border of the images by an error in the movement of the movable stage 102 at the time of the obtaining the nine images to be displayed in a correct shape.

The profile lines of the cells are highlighted by the processes at Steps S201 to S206, and the synthesized image where the cells present on the borders of a plurality of images are also displayed on a correct shape is created. Although the synthesized image is not appropriate for confirming micro cell organelles in the cells, it is appropriate to search an area of cell density suitable for an observation area.

Referring back to FIG. 7, if the synthesized image creating processing is completed, center image creating processing for observation is performed (Step S103).

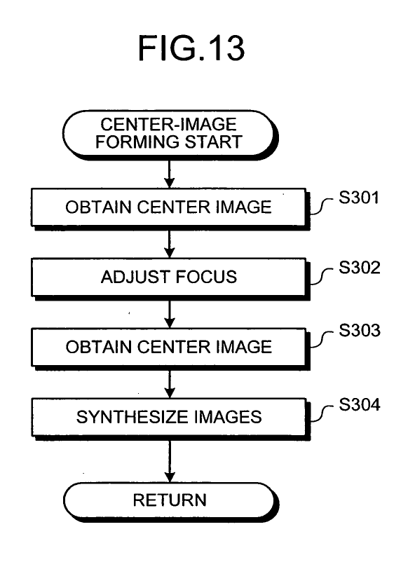

The center-image creation processing is executed in accordance with the procedure in the flowchart shown in FIG. 13. The-CCD camera 108 obtains the center image positioned at the center of the synthesized image (Step S301). The center image obtained here is the image of the magnified image where the objective lens 104 focuses the border between the upper surface of the dish 101 and the lower surface of the cell 302.

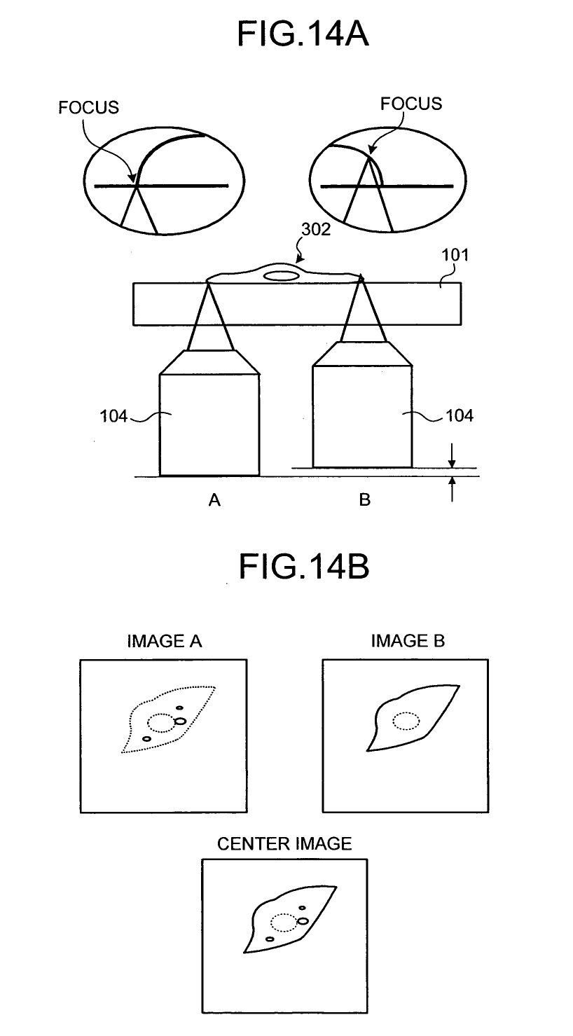

The objective lens 104 is adjusted to focus the cell membrane periphery of the cell 302 in accordance with the control of the control unit 110 as shown FIG. 14A B (Step S302). After the focus adjustment, the CCD camera 108 obtains the center image again (Step S303).

Although the cell 302 is closely contacted with the dish 101, it is of a shape that the outer periphery slightly rises from the upper surface of the dish 101, and the thickness is about 5 micrometers. In this case, if it focuses on the position shown in FIG. 14A A, for example, as in an image A in FIG. 14B, clear images of the micro cell organelle in the cell attached to the upper surface of the dish 101 are obtained. On the other hand, if the objective lens 104 is adjusted to focus a point about 2 micrometers to 5 micrometers above and it focuses the position B shown in FIG. 14A, for example, as in the image B shown in FIG. 14B, the clear image of the cell membrane in the cell 302 is obtained. Then, because the center-image processing unit 408 synthesizes the two images of different focuses (Step S304), a center image where both the profile line of the cell and the cell organelle inside are clear is obtained, as shown in FIG. 14B.

The center image where both the profile line of the cell and the cell organelle inside are clear is created by the processes at Steps S301 to 304. This center image is suitable for confirming the micro cell organelles in the cell.

Referring back to FIG. 7, the synthesized image and the center image created by the synthesized image creasing processing and the center-image creation processing are arranged and displayed on the monitor 111 as shown in FIG. 15 (Step S104). Even after the synthesized image and the center image are displayed on the monitor 111, if the operator changes the scope of the synthesized image, the synthesized-image creation processing per casual Step S102 is performed, accompanied with this procedure, the center-image creation processing at Step S103 is performed. In addition, updating of the center image is always repeated, and the latest status of the cell in the dish 101 is displayed on the monitor 111.

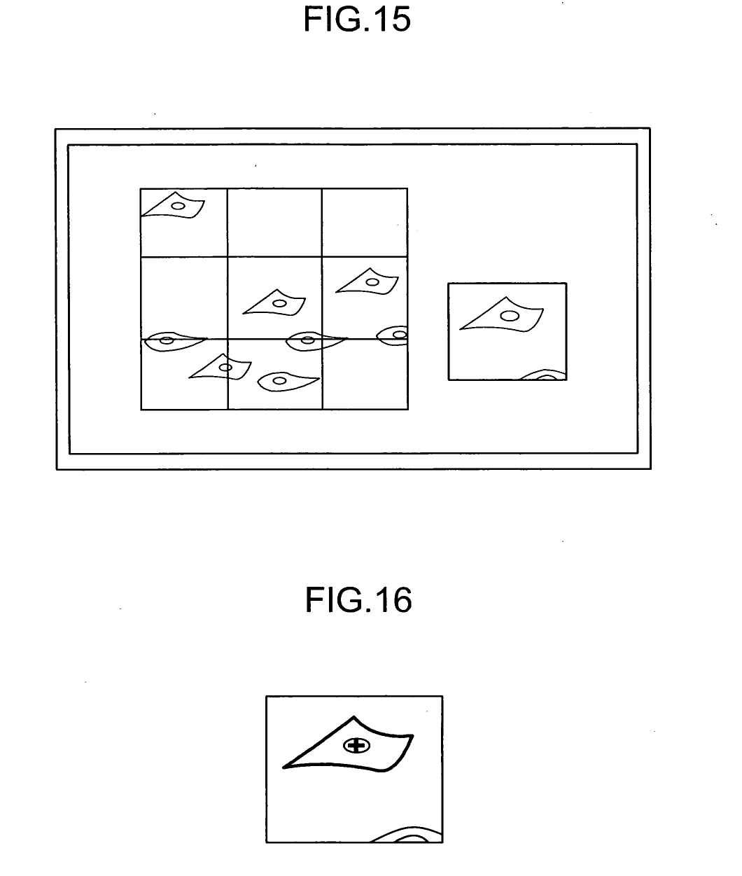

Thus, because the synthesized-image and the center image are arranged and displayed on the monitor 111, the operator can confirm a suitable observation area in the center image to perform the injection while confirming the synthesized image and searching the observation area of suitable cell density. To perform the injection, the operator operates the position input unit 112 while confirming the center image in the monitor 111, and designates a position on which the injection wants to be performed in the center image by a cross mark, or the like, for example, as shown in FIG. 16 (Step S105). This designation is noticed to the control unit 110, the control unit 110 controls the movable stage 102 and the capillary 5, and the injection is performed at the position designated by the operator (Step S106).

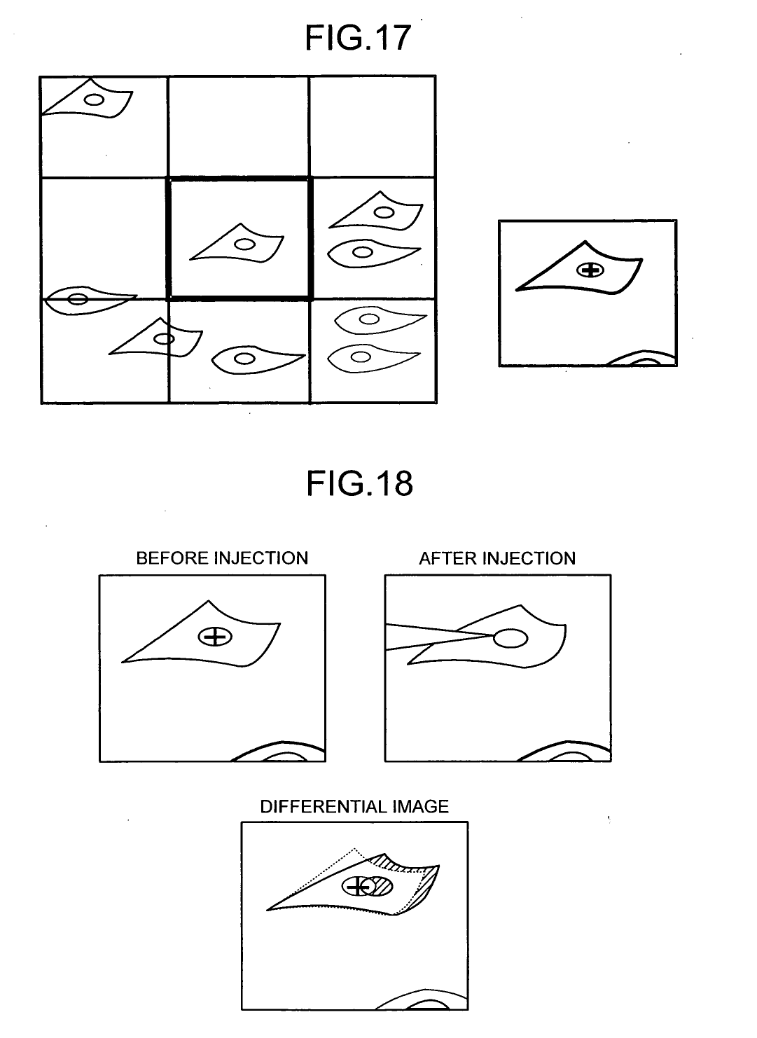

After the injection, the marking showing that the injection is performed is conducted in the synthesized image and the center image displayed on the monitor 111 (Step S107). Namely, the injection-position obtaining unit 410 of the image processing unit 109 obtains the information on the position where the injection is performed from the control unit 110, and the marking unit 411 marks the synthesized image held in the synthesized-image processing unit 405 and the center image held in the center-image processing unit 408. The marked synthesized image and center image are each output from the synthesized-image output unit 407 and the center-image output unit 409 to the control unit 110, and are displayed on the monitor 111. The marking unit 411 performs marking so as to highlight the image frame containing the injected cell with regard to the synthesized image and to highlight the profile line of the injected cell and the injection position with regard to the center image, for example, as shown in FIG. 17. The marking allows the operator to identify whether the injection is already performed on each image frame and each cell.

The search for the observation area by the synthesized image, the designation of the injection position by the center image, and the injection, the markings of the injection position are repeated, and injection is performed on a desired number of cells. If injection is performed on the desired number of the cells, the image processing unit 109 judges the effect of the injection (Step, S108). Namely, the differential-image creating unit 412 creates a differential image from the center images before and after the injection held in the center-image processing unit 408, and the judging unit 413 judges whether the size of the differential image is bigger than a predetermined threshold.

The differential-image creating unit 412 performs the creation of the differential image by finding a difference between the shape of the cell before injected in the center image and the shape of the cell after injected in the center image, for example, as shown in FIG. 18. In FIG. 18, the diagonal line portion in the lower drawing is found as a differential image. And, the judging unit 413 judges whether the area of the diagonal line portion is bigger than a predetermined threshold, it is judged that the injection is properly performed and the effect appears if it is bigger than the predetermined threshold. The judgment result is noticed to the center-image processing unit 408, processing such as coloring is performed on the cell where the effect of the injection appears so as to distinguish the same from other cells. The center-image output unit 409 outputs the center image to the control unit 110, and the image is displayed on the monitor 111. This allows the operator to easily confirm the cell where the effect of the injection appears. In addition, the judgment result by the judging unit 413 is also noticed to the synthesized-image processing unit 405, the image frame containing the cell where the effect of the injection appears may be colored so as to be able to distinguish the same from other image frames, as in the marking by the marking unit 411.

As described above, according to the first embodiment, the image of the periphery at the designated capturing position is obtained, the synthesized image obtained by synthesizing the obtained image and the center image disposed at the center of the synthesized image corresponding to the designated capturing position are arranged and displayed on the monitor. Therefore, the observation area suitable for injection can be searched while confirming the synthesized image that can grasp the surrounding conditions, and injection can be executed by confirming the center image that can grasp the micro structure of the cell at the same time, it takes few time to shift the objective lens, or the like, thereby enabling the improvement of the injection efficiency. In addition, because the synthesized image and the center image are created from the image magnified by the same objective lens, a plurality of objective lens of different magnifications is not required, thereby enabling the simplification of the unit configuration.

A second embodiment of the present invention features that a wider lattice map where an injectable area, an already injected area, a movable area of a cell, or the like is shown is displayed together with the synthesized image and the center image.

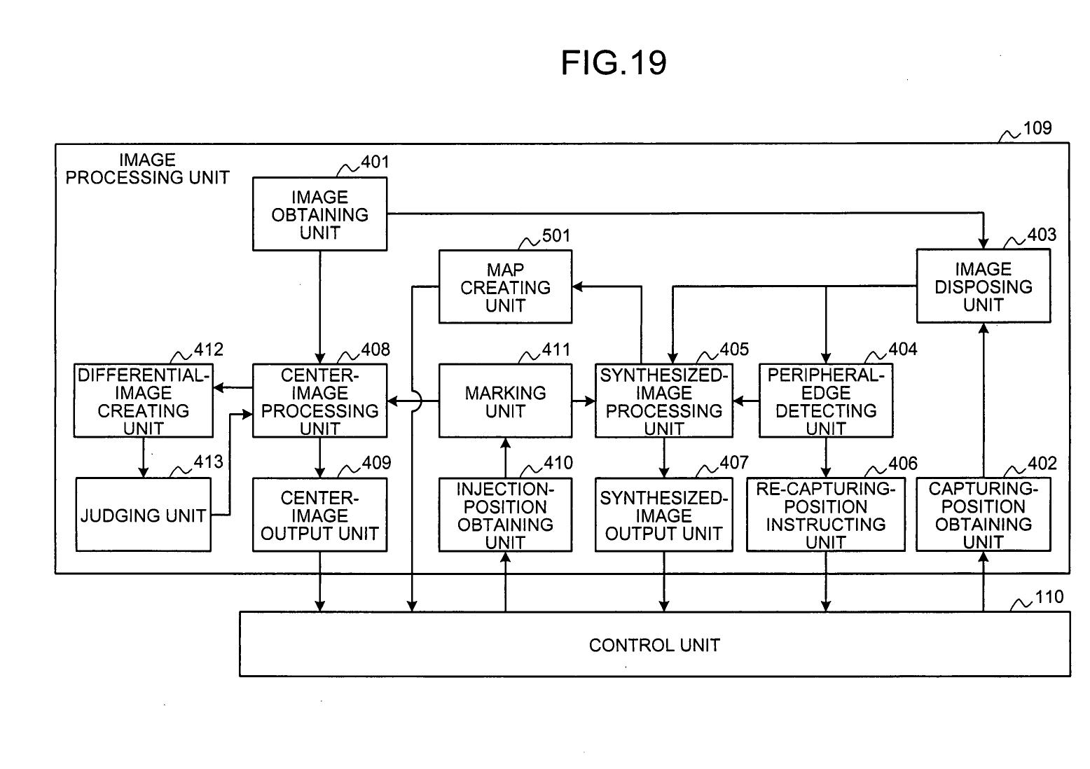

According to the second embodiment, the internal configuration of the image processing unit 109 is different from that of the first embodiment. FIG. 19 is a block diagram of an image processing unit 109 according to the second embodiment. The image processing unit 109 has according to the second embodiment has a configuration that a map creating unit 501 is added to the image processing unit 109 according to the first embodiment.

The map creating unit 501 creates a broader area lattice map where one lattice corresponds to one image frame from the synthesized image held in the synthesized-image processing unit 405. One side of one image frame corresponds to, for example, about 100 micrometers, while one side of one map corresponds to, for example, about 2 millimeters. The map creating unit 501 shows the image frame of cell density suitable for the injection found from the number of cells in each image frame configuring the synthesized image, the image frame where injection is completed, the image frame of a scope that a cell can move, or the like on the map and displays them in the monitor 111.

According to the second embodiment, for example, at the time of starting the injection apparatus, or the like, the CCD camera 108 sequentially captures the entire scope displayed on the map, and a broader image where each image is arranged is created.

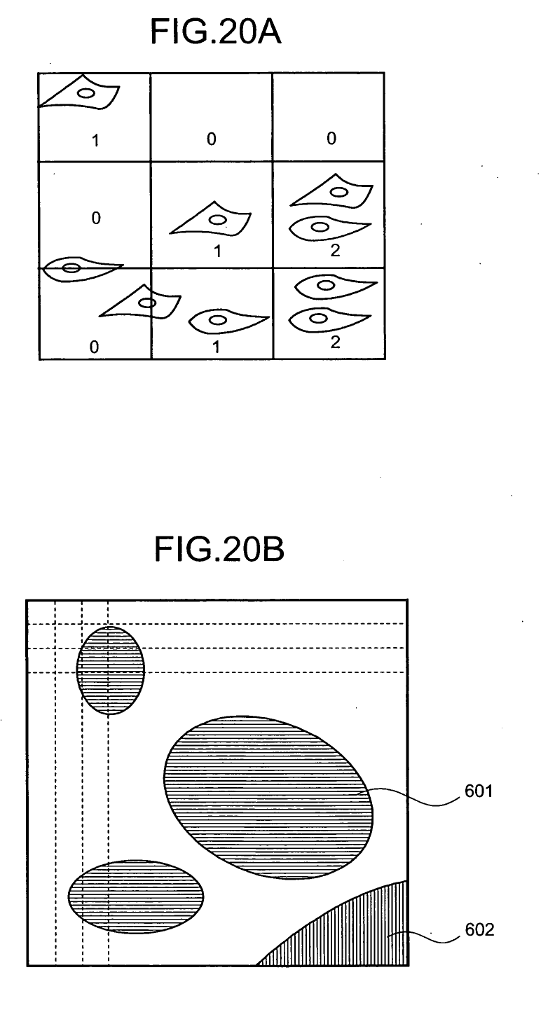

To show whether a cell is suitable for injection on the map, if each image in the broader image is one shown, for example, in FIG. 20A, the map creating unit 501 first counts and records the number of cells in each image frame. In FIG. 20, the numerals in each image frame show the number of cells. In addition, the cells on the borders of the image frames are determined not to be counted to simplify the image processing. And, the map creating unit 501 defines a lattice corresponding to an image frame of cell number of, for example, three to ten to be an area suitable for injection, and a lattice corresponding to an image frame of cell number of, for example, zero to two or eleven or more to be an area not suitable for injection, which are shown on the map by changing the colors, or the like. One example of this map is shown in FIG. 20B. In FIG. 20B, for example, a scope 601 shown in-the lateral lines is an area suitable for injection, and a scope 602 in the longitudinal lines is an area not suitable for injection.

The operator can roughly decide an objective scope in executing the injection by confirming such a map on the monitor 111 and designate the position where synthesized-image creation processing and center-image creation processing in the first embodiment are performed by operating the position input unit 112.

To show the image frame where the injection is completed on the map, the map creating unit 501 colors a lattice corresponding to the image frame marked on the synthesized image by the marking unit 411 to create the map, for example, shown in FIG. 21. In FIG. 21, the lattice shown in the diagonal lines corresponds to the image frame containing the cells where the injection is already completed. This allows the operator to roughly grasp the scope where injection is completed.

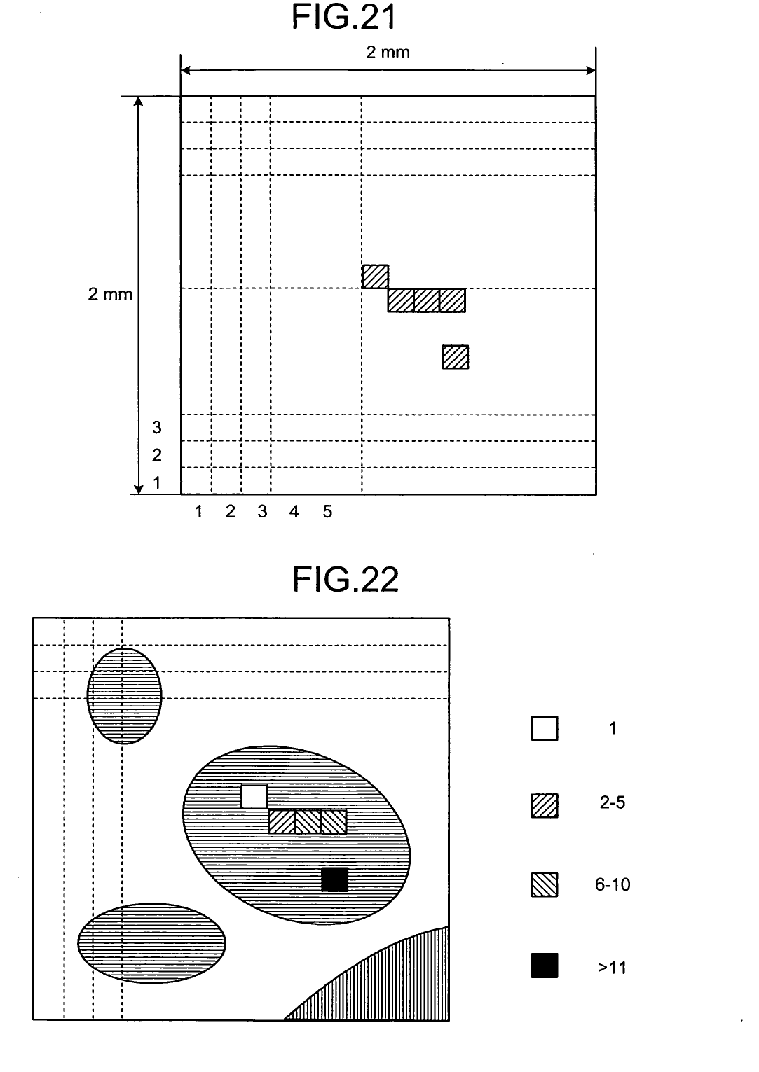

By counting the number of the cells where injection is performed in the image frame, and by changing the color of the lattice according to the number, the conditions of the injections can be grasped in detail, areas where the existence or non-existence of the effect should be observed can be intensively decided. At the same time, for example, as shown in FIG. 22, by showing the suitability or non-suitability of injection on the map, the operator can obtain a guideline of areas where injection should be advanced. In such a map, it is unnecessary to count and show the number of cells on all the image frames, after the number of cells on the image frames spaced out at a certain distance is counted, the lattices may be colored correspondingly to the number of the cells by a statistical processing.

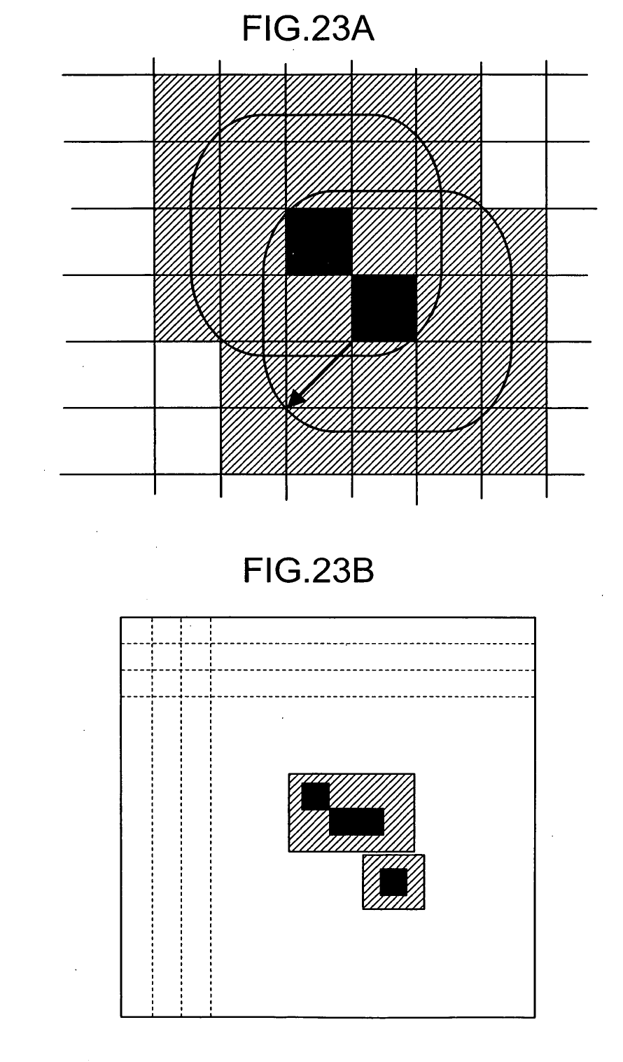

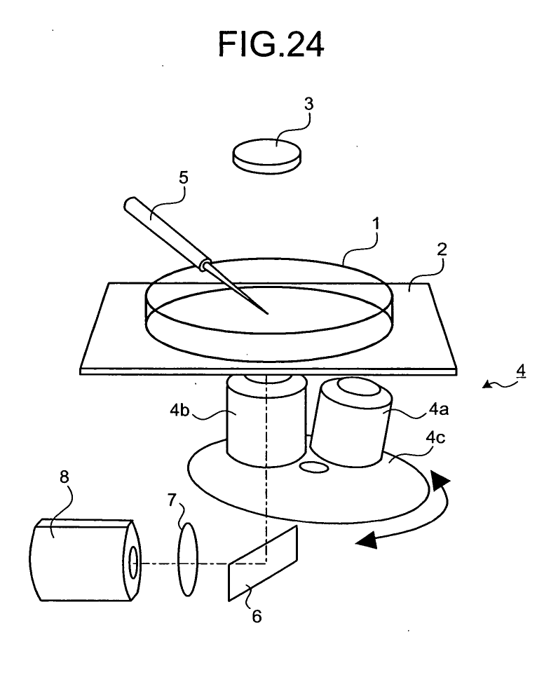

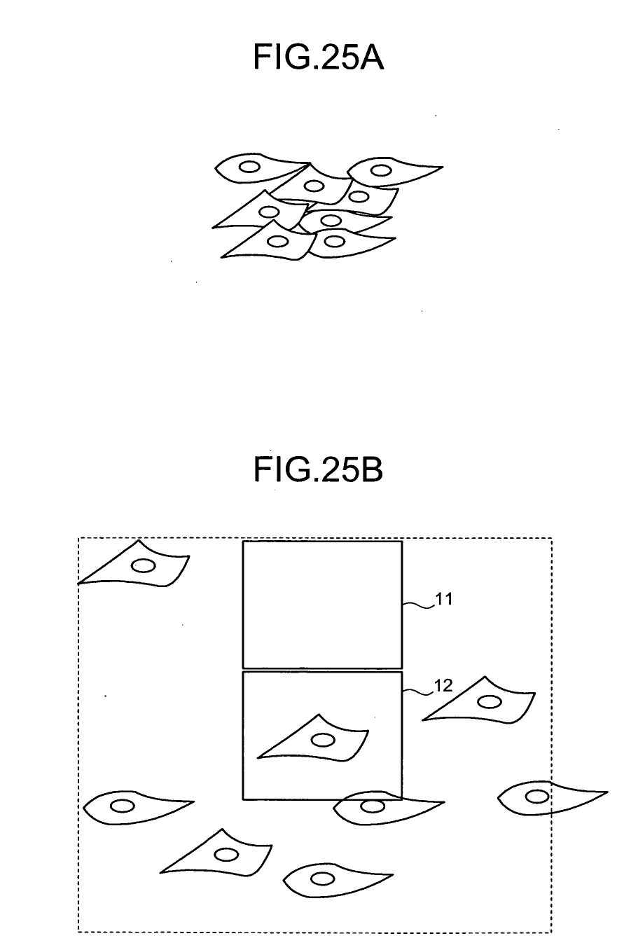

To indicate the image frame of the scope in which the cell is movable on the map, the lattice of the scope corresponding to the degree of activity and mobility speed of the cell may be colored. Here, because the cell may be movable, the cell may not be present even if the same position is observed after the injection. However, because the mobility speed of the cell is limited, for example, as shown in FIG. 23A, the cells present in the lattice shown in black merely move in the approximate distance shown by the arrow in the drawing even at the maximum. Then, if the lattice of the scope shown in the diagonal lines in FIG. 23-1 is colored as the movable scope of the cell, even when the effect is observed after the injection, the numbers of the cells which are the observation objects are not different from each other before and after the injection, and an efficient observation can be performed. Thus, the example showing the movable scope of the cell on the map is shown in FIG. 23A. In FIG. 23B, the black lattice corresponds to the area where the cell was present at the time of injection, and the lattice shown in the diagonal lines corresponds to the movable scope of the cells.

As described above, according to the second embodiment, the efficiency of the injection can be further improved because the compatibility or non-compatibility of the injection, the completion status of the injection, and the movable scopes of the cells are shown on a further broader lattice map.

According to the present invention, an operator can search an observation area of cell density suitable for injection while confirming the wide-field image and determine a detailed injection position while confirming the narrow-field image, thereby enabling the improvement of the injection efficiency. In addition, the operator can create a wide-field image and a narrow-field image using an image of the same magnification, thereby dispensing with objective lenses of different magnifications to result in a simple unit configuration.

Furthermore, according to the present invention, if the position of a substance to be injected and a substance injection position are input in the displayed narrow-field image, because the substance is injected into the substance injection position with a micro capillary just after inputting and a predetermined mark is synthesized at the substance injection position in the narrow-field image, it is unnecessary to store the coordinates of the input substance injection position and the substance injection position can be confirmed in the narrow-field image.

Moreover, according to the present invention, because a cell largely deformed by the injection can be classified and confirmed from other cells, the existence or non-existence of the effect can be easily grasped.

Furthermore, according to the present invention, because a map such that one lattice corresponds to one narrow-field image, the map is a lattice map corresponding to areas more than areas contained in the wide-field image, and the lattice corresponding to the narrow-field image where the injected cell is present is distinguished from other lattices is created, and the created map is displayed the narrow-field image and the wide-field image, a rough position relation between the observation areas corresponding to the wide-field image and the narrow-field image is grasped, and the positions of areas where injection is not completed can be easily confirmed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An injection apparatus comprising:
a capturing unit that captures an image of a designated position in a culture medium;
a first creating unit that creates a wide-field image by synthesizing a plurality of images of the designated position and a periphery of the designated position captured by the capturing unit;
a second creating unit that creates a narrow-field image using the image of the designated position captured by the capturing unit; and
a displaying unit that arranges and displays the wide-field image and the narrow-field image.

2. The injection apparatus according to claim 1, further comprising:
an input unit that inputs a position where a substance is injected in the narrow-field image displayed by the displaying unit, wherein
the second creating unit synthesizes a predetermined mark at the position of the narrow-field image input by the input unit.

3. The injection apparatus according to claim 1, further comprising:
an input unit that inputs a position where a substance is injected in the narrow-field image displayed by the displaying unit, wherein
the substance is injected into the position using a micro capillary immediately after the position is input by the input unit.

4. The injection apparatus according to claim 1, wherein
the first creating unit includes a detecting unit that detects a periphery of a cell by edge detecting in the wide-field image; and
a processing unit that performs a processing of highlighting the periphery of the cell detected by the detecting unit in the wide-field image.

5. The injection apparatus according to claim 1, wherein
the second creating unit performs a processing of detecting and highlighting a periphery of a cell by edge detecting in the narrow-field image.

6. The injection apparatus according to claim 1, wherein
the second creating unit creates the narrow-field image by synthesizing a plurality of images of the designated position captured by the capturing unit with different focuses.

7. The injection apparatus according to claim 6, wherein
the second creating unit creates the narrow-field image by synthesizing an image captured by the capturing unit with a focus on a surface of a cell and an image captured by the capturing unit with a focus on a position deviated by 2 micrometers to 5 micrometers above an upper surface of a dish.

8. The injection apparatus according to claim 1, wherein
the first creating unit includes
a detecting unit that detects a periphery of a cell by edge detecting in the wide-field image;
an instructing unit that instructs, when the periphery of the cell detected by the detecting unit intersects with a border of the images forming the wide-filed image, a position of the cell as a re-capturing position to the capturing unit; and
a processing unit that overwrites the re-capturing position of the wide-field image with images re-captured captured by the capturing unit, and synthesizes the overwritten images.

9. The injection apparatus according to claim 8, wherein
the processing unit cuts off a minimum area including the cell from the image re-captured by the capturing unit before overwriting and synthesizing the re-capturing position of the wide-field image.

10. The injection apparatus according to claim 1, further comprising:
an input unit that inputs a position where a substance is injected in the narrow-field image displayed by the displaying unit, wherein
the second creating unit performs a processing of highlighting a periphery of a cell located at the position of the narrow-field image input by the input unit.

11. The injection apparatus according to claim 1, further comprising:
an input unit that inputs a position where a substance is injected in the narrow-field image displayed by the displaying unit, wherein
the first creating unit performs, upon the input unit inputting the position, a processing of highlighting an image frame corresponding to the narrow-field image displayed by the displaying unit in the wide-field image.

12. The injection apparatus according to claim 1, further comprising:
a third creating unit that creates a differential image of the narrow-field image before and after the substance is injected; and
a judging unit that judges whether a size of the differential image is larger than a predetermined threshold, wherein
the second creating unit performs a processing of highlighting a cell in the narrow-field image with the size of the differential image larger than the predetermined threshold as a cell having an effect of a substance, based on a result of judgment by the judging unit.

13. The injection apparatus according to claim 1, wherein
the displaying unit displays a predetermined symbol inducing a change of the designated position to a periphery of the wide-field image, and
the capturing unit captures the image of the designated position designated in response to the predetermined symbol displayed by the displaying unit.

14. The injection apparatus according to claim 1, further comprising:
a fourth creating unit that creates a map in a lattice shape of which one lattice corresponds to one narrow-field image, and covers an area larger than areas includes in the wide-field image, wherein
the displaying unit displays the map created by the fourth creating unit together with the wide-field image and the narrow-field image.

15. The injection apparatus according to claim 14, wherein
the fourth creating unit creates the map by distinguishing a lattice corresponding to each narrow-field image according to number of the cells present in the narrow-field image.

16. The injection apparatus according to claim 14, wherein
the fourth creating unit creates the map by distinguishing a lattice corresponding to the narrow-field image where a substance-injected cell is present from other lattices.

17. The injection apparatus according to claim 14, wherein
the fourth creating unit creates the map by distinguishing a lattice corresponding to an area where a cell present in the narrow-field image is movable from other lattices.

18. The injection apparatus according to claim 1, further comprising:
an adjusting unit that adjusts a position of a container that contains the culture medium.

19. The injection apparatus according to claim 18, wherein
the adjusting unit includes
a holding member that fixes and holds the container; and
a projection that makes a contact with the holding member, and determines a position of the holding member.

20. The injection apparatus according to claim 19, wherein
the adjusting unit further includes a position reference member on which a predetermined mark indicating a reference of the position of the holding member is formed, and fixes a position of the predetermined mark.

21. The injection apparatus according to claim 19, wherein
the holding member includes a position reference member on which a predetermined mark indicating a reference of the position of the holding member is formed, and fixes a position of the predetermined mark.

22. A method of displaying an image including a cell when injecting a substance into the cell in a culture medium using a micro capillary, the method comprising:
first capturing including capturing images of a designated position in the culture medium and a periphery of the designated position;
first creating including creating a wide-field image by synthesizing the images of the designated position and the periphery of the designated position captured at the first capturing;
second capturing including capturing an image of the designated position in the culture medium;
second creating including creating a narrow-field image using the image of the designated position captured at the second capturing; and
arranging and displaying the wide-field image and the narrow-field image.
